(19) United States
(12) Patent Application Publication
(10) Pub. No.: US 2020/0311554 A1
(43) Pub. Date: Oct. 1, 2020

(54) PERMUTATION-INVARIANT OPTIMIZATION METRICS FOR NEURAL NETWORKS

(71) Applicant: INTERNATIONAL BUSINESS MACHINES CORPORATION, Armonk, NY (US)

(72) Inventor: Masataro Asai, Tokyo (JP)

(21) Appl. No.: 16/366,678

(22) Filed: Mar. 27, 2019

(51) Int. Cl. G06N 3/08; G06N 3/04; G06F 17/18

(52) U.S. Cl. CPC G06N 3/084; G06F 17/18; G06N 3/0454

(57) ABSTRACT

Permutation-invariant neural networks are trained by calculating a pairwise distance between each of a plurality of elements of a first data and each of a plurality of elements of a second data, normalizing each pairwise distance with a normalizing function to obtain a normalized value corresponding to each pairwise distance, de-normalizing a summation of the normalized values of all pairwise distances between a single element of the second data and each element of the first data with a de-normalizing function to obtain a first value, for each element of the second data, estimating a summation of the first values for all elements of the second data, and training a neural network by using at least the summation of the first values for an optimization metric.

### BACKGROUND

The following disclosure(s) are submitted under 35 U.S.C. 102(b)(1)(A): DISCLOSURES:

(1) Likelihood-based Permutation Invariant Loss Function for Probability Distributions, Masataro Asai, 28 Sep. 2018, ICLR 2019 Conference Blind Submission, https://openreview.net/forum?id=rJxpuoCqtQ,
(2) Set Cross Entropy: Likelihood-based Permutation Invariant Loss Function for Probability Distributions, Masataro Asai, submitted on 4 Dec. 2018 [v1]; 5 Dec. 2018[v2], https://arxiv.org/abs/1812.01217.

### TECHNICAL FIELD

The present invention relates to permutation-invariant optimization metrics for neural networks.

### DESCRIPTION OF THE RELATED ART

In computer science, it is sometimes necessary to handle data including a plurality of elements. For example, data of a set of fruits (e.g., a set of an apple, an orange, and a peach) may be used to represent a preference of a certain customer. The order of elements in the set may not be important, and may thus be ignored for such data. For example, data (apple, orange, peach) may be treated the same as data (peach, apple, orange).

However, conventional neural networks, such as autoencoders, treat data including the same elements with a different order as different data. According to conventional neural networks, it may be necessary to prepare data of all orders for each data, requiring consumption of an excessive amount of computational resources.

### SUMMARY

According to an aspect of the present invention, provided is a computer-implemented method for training neural network, including calculating a pairwise distance between each of a plurality of elements of a first data and each of a plurality of elements of a second data, normalizing each pairwise distance with a normalizing function to obtain a normalized value corresponding to each pairwise distance, de-normalizing a summation of the normalized values of all pairwise distances between a single element of the second data and each element of the first data with a de-normalizing function to obtain a first value, for each element of the second data, estimating a summation of the first values for all elements of the second data, and training a neural network by using at least the summation of the first values for an optimization metric.

The foregoing aspect may also include an apparatus configured to perform the computer-implemented method, and a computer program product storing instructions embodied on a computer-readable medium or programmable circuitry, that, when executed by a processor or the programmable circuitry, cause the processor or the programmable circuitry to perform the method. The summary clause does not necessarily describe all features of the embodiments of the present invention. Embodiments of the present invention may also include sub-combinations of the features described above.

### BRIEF DESCRIPTION OF THE DRAWINGS

FIG. 1 shows an exemplary configuration of an apparatus 10, according to an embodiment of the present invention.

FIG. 2A shows a neural network according to an embodiment of the present invention.

FIG. 2B shows a neural network according to another embodiment of the present invention.

FIG. 3 shows an operational flow according to an embodiment of the present invention.

FIG. 4 shows pairwise distances according to an embodiment of the present invention.

FIG. 5 shows normalized pairwise distances according to an embodiment of the present invention.

FIG. 6 shows first values according to an embodiment of the present invention.

FIG. 7 shows an exemplary hardware configuration of a computer that functions as a system, according to an embodiment of the present invention.

### DETAILED DESCRIPTION

Hereinafter, example embodiments of the present invention will be described. The example embodiments shall not limit the invention according to the claims, and the combinations of the features described in the embodiments are not necessarily essential to the invention.

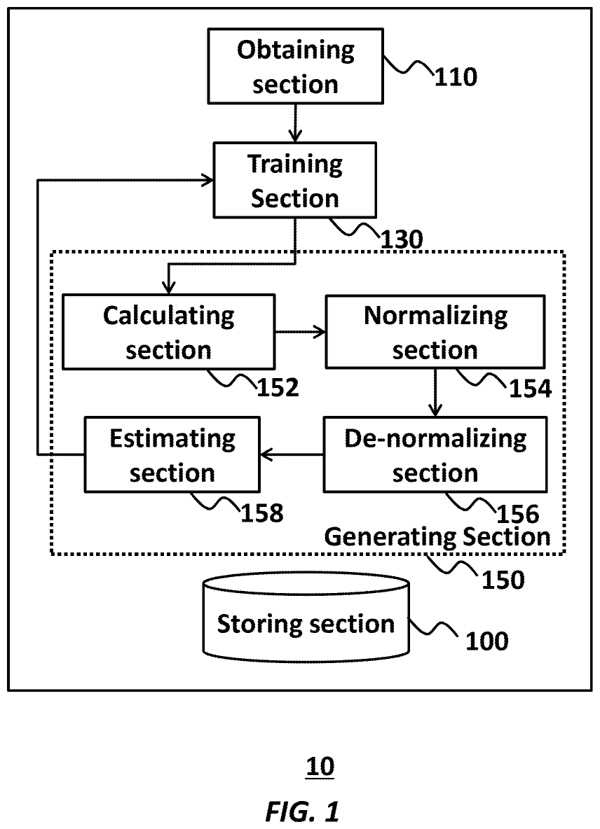

FIG. 1 shows an exemplary configuration of an apparatus 10, according to an embodiment of the present invention. The apparatus 10 may train neural networks with a permutation-invariant optimization metric. Thereby, the apparatus 10 may generate neural networks that can process data including permutation-invariant elements, much faster and/or with less computational resources.

The apparatus 10 may include a processor and/or programmable circuitry. The apparatus 10 may further include one or more computer readable mediums collectively including instructions. The instructions may be embodied on the computer readable medium and/or the programmable circuitry. The instructions, when executed by the processor or the programmable circuitry, may cause the processor or the programmable circuitry to operate as a plurality of operating sections.

Thereby, the apparatus 10 may be regarded as including a storing section 100, an obtaining section 110, a training section 130, and a generating section 150.

The storing section 100 stores information used for the processing that the apparatus 10 performs. The storing section 100 may also store a variety of data/instructions used for operations of the apparatus 10.

One or more other elements in the apparatus 10 (e.g., the obtaining section 110, the training section 130, and the generating section 150) may communicate data directly or via the storing section 100, as necessary.

The storing section 100 may be implemented by a volatile or non-volatile memory of the apparatus 10. In some embodiments, the storing section 100 may store neural networks, parameters, and other data related thereto.

The obtaining section 110 obtains a plurality of training data used for training of a neural network. The obtaining section 110 may obtain other data necessary for operations of the apparatus 10. The obtaining section 110 may provide the training section 130 with the plurality of training data.

The training section 130 trains neural networks by using the plurality of training data provided by the obtaining section 110. The training section 130 may train neural networks so as to output data including the same elements as input data regardless of orders of the elements.

The training section 130 may use each of the plurality of training data as input data during the training. The training section 130 may train the neural network by using at least an optimization metric. In an embodiment, the optimization metric may be a network loss function.

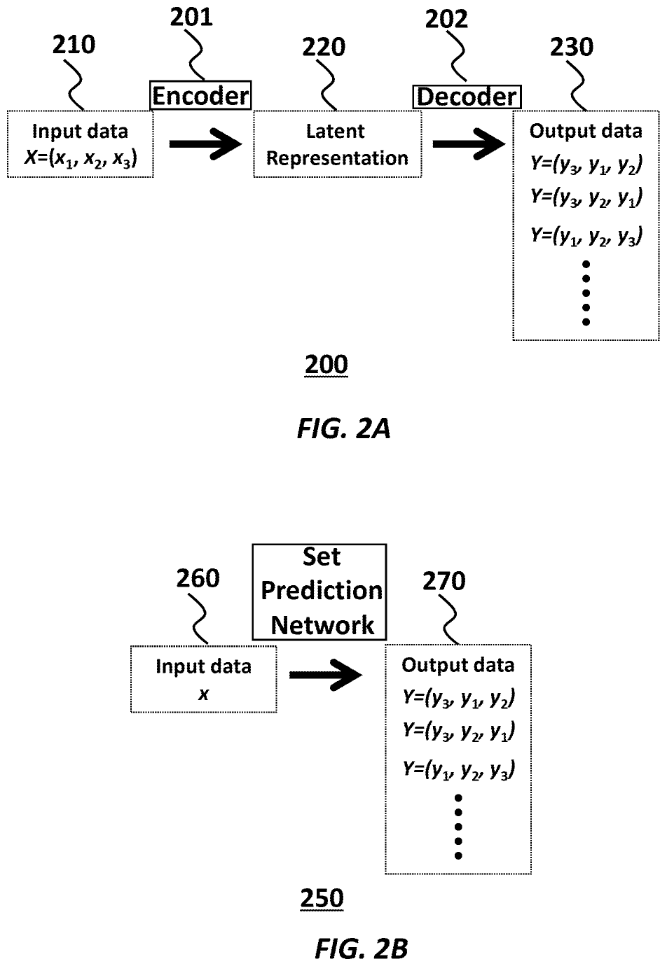

FIG. 2A shows a neural network 200 according to an embodiment of the present invention. In an embodiment, training section 130 may train at least a part of an autoencoder, such as a Variational Autoencoder (VAE), as the neural network 200. In the embodiment, the neural network 200 may include an encoder 201 and a decoder 202. In some embodiments, the neural networks can be implemented in either software or hardware. It should be understood that the present architecture is purely exemplary, and that other architectures or types of neural network can be used instead.

In the embodiment of FIG. 2A, the encoder 201 transforms an input data X 210 into a latent representation 220 that represents the input data X 210. The input data X 210 may include x₁, x₂, and x₃ in this order as elements. The decoder 202 transforms the latent representation 220 into an output data Y 230. The output data Y 230 may include y₁, y₂, and y₃ in this order as elements.

The element y₁ corresponds to the element x₁, the element y₂ corresponds to the element x₂, and the element y₃ corresponds to the element x₃. The order of the elements in the output data Y 230 may or may not be the same as the input data X 210. For example, the output data Y 230 may include y₃, y₁, and y₂ in this order, OR y₃, y₂, and y₁ in this order, OR y₁, y₂, and y₃ in this order.

During the training, the training section 130 may obtain output data corresponding to the input data, and provide the generating section 150 with the input data and the output data. Then, the training section 130 may receive first values from the generating section 150, and then train the neural network by using the first values for an optimization metric.

FIG. 2B shows a neural network according to another embodiment of the present invention. In the embodiment of FIG. 2B, the neural network 250 may be a set prediction network that is used for a set prediction task. For example, the training section 130 may train the neural network 250 using input data x 260 including an element and teacher data including a plurality of elements so as to output Output data 270 corresponding to the teacher data.

The generating section 150 generates the optimization metric used for the training of the training section 130. In an embodiment, the optimization metrics may be a network loss function. In an embodiment, the generating section 150 may receive the input data and the output data as first data and second data from the training section 130.

Then, the generating section 150 may generate a network loss function of the first data and the second data. The generating section 150 may comprise a calculating section 152, a normalizing section 154, a de-normalizing section 156, and an estimating section 158.

The calculating section 152 calculates a pairwise distance between elements of the first data and the second data. The first data and the second data may each include a plurality of elements. In an embodiment, the calculating section 152 may calculate the pairwise distance between each of a plurality of elements of the first data and each of a plurality of elements of the second data.

The normalizing section 154 normalizes the pairwise distance calculated by the calculating section 152. In an embodiment, the normalizing section 154 may normalize each pairwise distance with a normalizing function to obtain a normalized value corresponding to each pairwise distance. In an embodiment, the normalizing function may perform the normalization by projecting a positive input value (e.g., [0, ∞]) to a certain positive range (e.g., [0, 1]).

The de-normalizing section 156 may calculate a summation of the normalized values. In an embodiment, the de-normalizing section 156 may calculate a summation of the normalized values of all pairwise distances between a single element of the second data and each element of the first data, for each element of the second data.

The de-normalizing section 156 de-normalizes the calculated summation of the normalized values. In an embodiment, the de-normalizing section 156 may de-normalize the calculated summation to obtain a first value for each element of the second data. In an embodiment, the de-normalizing section 156 may smooth minimize all pairwise distances between a single element of the second data and each element of the first data with a de-normalizing function, for each element of the second data. In an embodiment, the de-normalizing function may be associated with an inverse function of the normalizing function.

The estimating section 158 estimates a summation of the first values. In an embodiment, the estimating section 158 may estimate a summation of the first values for all elements of the second data used for an optimization metric.

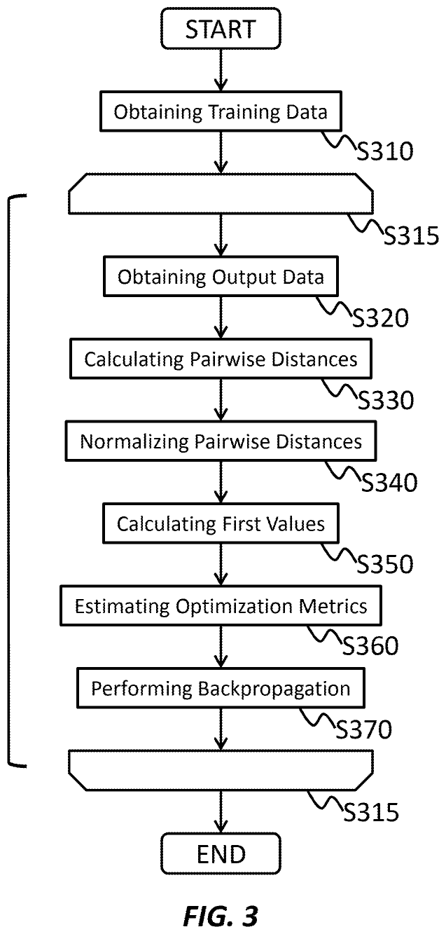

FIG. 3 shows an operational flow according to an embodiment of the present invention. The present embodiment describes an example in which an apparatus, such as the apparatus 10, performs operations from S310 to S370, as shown in FIG. 3, to train a neural network.

At S310, an obtaining section, such as the obtaining section 110, obtains a plurality of training data. Each training data may include a plurality of elements. Each of the plurality of elements may include a plurality of features. In an embodiment, the training data X may be represented as:

X={x₁,x₂, . . . ,x₀}∈[0,1]^{O×F},xᵢ∈[0,1]^{F} EQ1

where xᵢ corresponds to each element of the plurality of elements, O is a number of elements in the plurality of elements, and F is a number of features in each element. Thereby, each training data may be regarded as comprising a plurality of vectors x₁, x₂, . . . x_{O}, each of which represents each of the plurality of elements.

In an embodiment, each element of the training data may represent an item (e.g., a word “orange”). In other embodiments, each element may represent an image, an audio, a text, a video, etc. The obtaining section may provide a training section, such as the training section 130, with the plurality of training data.

After the operation of S310, the apparatus iterates loop S315 for each of the plurality of training data. The apparatus performs operations S320-S370 for each iteration of loop S315. Thereby, the apparatus trains a neural network with the plurality of training data. Hereinafter, training data to be processed in a single iteration of loop S315 may be referred to as “target training data.”

At S320, the training section obtains output data corresponding to the target training data. In an embodiment, the training section may input the target training data into a neural network to be trained, and calculate the output data from the neural network. The training section may calculate outputs of nodes from an input layer to an output layer in the neural network.

The output data has a structure corresponding to the target training data and has a plurality of elements. In an embodiment, the output data Y may be represented as:

Y={y₁,y₂, . . . ,y₀∈}[0,1]^{O×F},yᵢ∈[0,1]^{F} EQ2,

where yᵢ corresponds to each elements of the plurality of elements, and O and F are the same as defined in EQ1.

The training section may provide a generating section, such as the generating section 150, with the target training data and the output data. In an embodiment, the generating section may treat the target training data as “first data”, and the output data as “second data.” In another embodiment, the generating section may treat the target training data as “second data”, and the output data as “first data.”

At S330, a calculating section, such as the calculating section 152, calculates a pairwise distance between each of the plurality of elements of the first data and each of the plurality of elements of the second data. The calculating section may use at least one variety of distance function for calculating the pairwise distance.

Each pairwise distance represents a distance between the element of the first data and the element of the second data. Each pairwise distance may include a Kullback-Leibler divergence of the element of the first data and the element of the second data.

In an embodiment, each pairwise distance is associated with a cross entropy of the element of the first data and the element of the second data. In another embodiment, each pairwise distance is associated with a mean squared error of the element of the first data and the element of the second data.

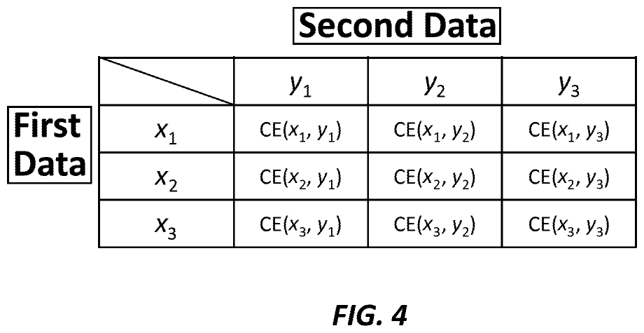

FIG. 4 shows pairwise distances according to an embodiment of the present invention. In the embodiment of FIG. 4, the first data X includes x₁, x₂, and x₃ as elements in this order, while the second data Y includes y₁, y₂, and y₃ in this order as elements.

In the embodiment, the calculating section may calculate a cross entropy CE(x₁, y₁), a cross entropy CE(x₂, y₁), a cross entropy CE(x₃, y₁), a cross entropy CE(x₁, y₂), a cross entropy CE(x₂, y₂), a cross entropy CE(x₃, y₂), a cross entropy CE(x₁, y₃), a cross entropy CE(x₂, y₃), and a cross entropy CE(x₃, y₃) as each pairwise distance.

At S340, the normalizing section normalizes each pairwise distance with a normalizing function to obtain a normalized value corresponding to each pairwise distance. The normalizing function may be a convex function having an apex pointed in a negative direction. In an embodiment, the normalizing function is such that the value of the normalizing function is above 0 and upper-bounded by a finite constant, the first derivative of the normalizing function is below 0 and the second derivative of the normalizing function is above 0 for an input that is greater than or equal to 0.

For example, the normalizing function may be an exponential decaying function. In the example, the normalizing function may be exp(−x). In another example, the normalizing function may be associated with an inversed power function. In the example, the normalizing function may be 1/(x^{a}+1), where a may be any positive number such as 0.5, 1, 2, etc.

In some embodiments, the normalizing function may be non-differentiable and/or non-smooth function. For example, the normalizing function may be non-smooth approximations of above explained functions.

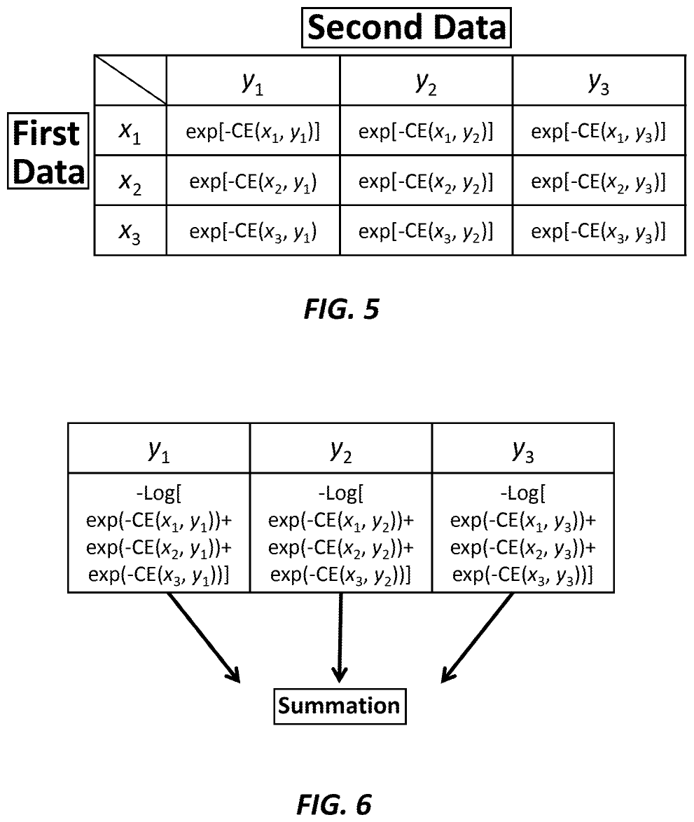

FIG. 5 shows normalized pairwise distances according to an embodiment of the present invention. In the embodiment of FIG. 5, the normalizing section calculates the normalized values from the pairwise distances shown in FIG. 4.

The normalizing section may calculate a normalized value: exp[−CE(x₁, y₁)] from the pairwise distance CE(x₁, y₁). Similarly, the normalizing section may calculate exp[−CE(x₂, y₁)] . . . exp[−CE(x₃, y₃)] from the pairwise distances CE(x₂, y₁) . . . CE(x₃, y₃). The normalizing section may provide a de-normalizing section such as the de-normalizing section 156 with the normalized values.

At S350, the de-normalizing section calculates first values from the normalized values. In an embodiment, the de-normalizing section may firstly calculate a summation of the normalized values of all pairwise distances between a single element of the second data and each element of the first data with a de-normalizing function, for each element of the second data. Then, the de-normalizing section 156 may further de-normalize the calculated summation to obtain a first value for each element of the second data.

In an embodiment, the de-normalizing function is an inverse function of the normalizing function. For example, when the normalizing function used at S340 is an exponential function (e.g., exp(−x)), the de-normalizing function may be a corresponding logarithm function (e.g., −log(x)). When the normalizing function used at S340 is associated with an inversed power function (e.g., 1/(x^{a}+1)), the de-normalizing function may be a corresponding function (e.g., (1/x−1)^{1/a}).

FIG. 6 shows first values according to an embodiment of the present invention. In the embodiment of FIG. 6, the de-normalizing section calculates the first values from the normalized values shown in FIG. 5.

The de-normalizing section may calculate a first value: −log(exp[−CE(x₁, y₁)]+exp[−CE(x₂, y₁)]+exp[−CE(x₃, y₁)]) which may be represented as −logsumexp_{y1}(−CE(x,y)) for the element y₁ of the second data. The de-normalizing section may also calculate a first value: −log(exp[−CE(x₁, y₂)]+exp[−CE(x₂, y₂)]+exp[−CE(x₃, y₂)]) which may be represented as −logsumexp_{y2}(−CE(x,y)) for the element y₂ of the second data.

The de-normalizing section may also calculate a first value: −log(exp[−CE(x₁, y₃)]+exp[−CE(x₂, y₃)]+exp[−CE(x₃, y₃)]) which may be represented as −logsumexp_{y3}(−CE(x,y)) for the element y₃ of the second data. The de-normalizing section may provide an estimating section, such as the estimating section 158, with the first values.

At S360, the estimating section estimates a summation of the first values for all elements of the second data. In the embodiment of FIG. 6, the estimating section may calculate: −log(exp[−CE(x₁, y₁)]+exp[−CE(x₂, y₁)]+exp[−CE(x₃, y₁)])−log(exp[−CE(x₁, y₂)]+exp[−CE(x₂, y₂)]+exp[−CE(x₃, y₂)])−log(exp[−CE(x₁, y₃)]+exp[−CE(x₂, y₃)]+exp[−CE(x₃, y₃)]) which may be represented as Σ_{x∈X}−logsumexp_{y∈Y}(−CE(x,y)). The estimating section may provide the training section with the summation of the first values.

Assume that the elements x₁, x₂, and x₃ correspond to y₁, y₂, and y₃, but are ordered in a different manner. For example, the elements x₁ and y₂ are A (e.g., a representation of “apple”), the elements x₂ and y₃ are B (e.g., a representation of “orange”), and the elements x₃ and y₁ are C (e.g., a representation of “peach”).

In such a case, all of the first values are approximately 0. This is because exp[−CE(x₁, y₂)], exp[−CE(x₂, y₃)], and exp[−CE(x₃, y₁)] are approximately 1 while other normalized values are approximately 0. As such, when elements of the first data and the second are the same but only differ in order thereof, the estimating section calculates the summation Σ_{x∈X}−logsumexp_{y∈Y}(−CE(x,y)) as approximately 0.

Meanwhile, when the elements x₁, x₂, and x₃ do not fully correspond to y₁, y₂, and y₃, at least a part of the first values have some positive value and are not substantially 0. As such, when elements of the first data and the second are at least partially different, the estimating section calculates the summation Σ_{x∈X}−logsumexp_{y∈Y}(−CE(x,y)) as having some negative value.

At S370, the training section updates parameters of the neural network by using the summation of the first values for the optimization metric. In an embodiment, the training section may perform backpropagation of the neural network by using the summation of the first values as a network loss function. For example the training section may use Σ_{x∈X}−logsumexp_{y∈Y}(−CE(x,y)) as the network loss function. Thereby, the training section may train weights of nodes in the neural network so as to minimize the network loss function which utilizes the summation of the first values.

As explained in relation to the operation of S360, the summation of the first values (e.g., Σ_{x∈X}−logsumexp_{y∈Y}(−CE(x,y))) include pairwise distances (e.g., −CE(x,y)) of all pairs of elements of the first data and elements of the second data. The summation of the first value is not substantially changed when orders of elements in the first data and/or the second data have altered. As such the summation of the first value is not affected by the order of elements of the first and second data. Therefore, the training section may train a neural network that substantially ignores the order of elements, thereby processing them with less computational resources.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

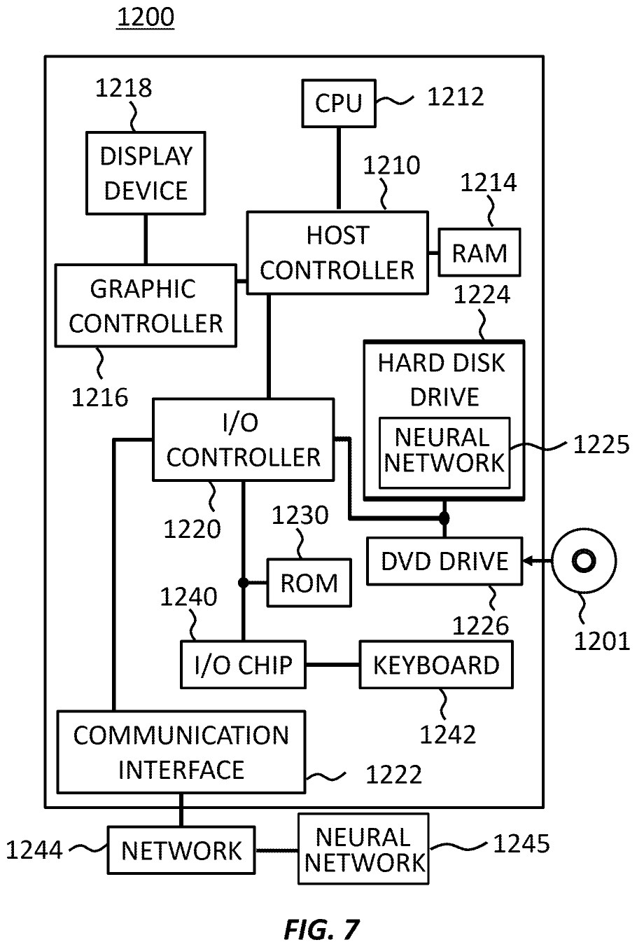

FIG. 7 shows an example of a computer 1200 in which aspects of the present invention may be wholly or partly embodied. A program that is installed in the computer 1200 can cause the computer 1200 to function as or perform operations associated with apparatuses of the embodiments of the present invention or one or more sections thereof, and/or cause the computer 1200 to perform processes of the embodiments of the present invention or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, a graphics controller 1216, and a display device 1218, which are mutually connected by a host controller 1210. The computer 1200 also includes input/output units such as a communication interface 1222, a hard disk drive 1224, a DVD-ROM drive 1226 and an IC card drive, which are connected to the host controller 1210 via an input/output controller 1220. The computer also includes legacy input/output units such as a ROM 1230 and a keyboard 1242, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on the display device 1218.

The communication interface 1222 communicates with other electronic devices via a network 1244. The hard disk drive 1224 stores programs and data used by the CPU 1212 within the computer 1200. The DVD-ROM drive 1226 reads the programs or the data from the DVD-ROM 1201, and provides the hard disk drive 1224 with the programs or the data via the RAM 1214. The IC card drive reads programs and data from an IC card, and/or writes programs and data into the IC card. In some embodiments, the neural network 1225 can be stored on hard disk drive 1124. The computer 1200 can train the neural network 1245 stored on the hard disk drive 1224 for the optimization metric.

The ROM 1230 stores therein a boot program or the like executed by the computer 1200 at the time of activation, and/or a program depending on the hardware of the computer 1200. The input/output chip 1240 may also connect various input/output units via a parallel port, a serial port, a keyboard port, a mouse port, and the like to the input/output controller 1220.

A program is provided by computer readable media such as the DVD-ROM 1201 or the IC card. The program is read from the computer readable media, installed into the hard disk drive 1224, RAM 1214, or ROM 1230, which are also examples of computer readable media, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the hard disk drive 1224, the DVD-ROM 1201, or the IC card, and transmits the read transmission data to a network 1244 or writes reception data received from a network 1244 to a reception buffering region or the like provided on the recording medium.

In addition, the CPU 1212 may cause all or a necessary portion of a file or a database to be read into the RAM 1214, the file or the database having been stored in an external recording medium such as the hard disk drive 1224, the DVD-ROM drive 1226 (DVD-ROM 1201), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 1200. In addition, a recording medium such as a hard disk or a RAM provided in a server system connected to a dedicated communication network 1244 or the Internet can be used as the computer readable media, thereby providing the program to the computer 1200 via the network 1244. In some embodiments, the computer 1200 can communicate with a neural network 1245 over the network 1244. The computer 1200 can train the neural network 1245 over the network 1244 for the optimization metric. The neural network 1245 can be embodiment as one or more nodes.

While the embodiments of the present invention have been described, the technical scope of the invention is not limited to the above described embodiments. It will be apparent to persons skilled in the art that various alterations and improvements can be added to the above-described embodiments. It should also apparent from the scope of the claims that the embodiments added with such alterations or improvements are within the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A computer-implemented method for training neural network, comprising:
calculating a pairwise distance between each of a plurality of elements of a first data and each of a plurality of elements of a second data;
normalizing each pairwise distance with a normalizing function to obtain a normalized value corresponding to each pairwise distance;
de-normalizing a summation of the normalized values of all pairwise distances between a single element of the second data and each element of the first data with a de-normalizing function to obtain a first value, for each element of the second data;
estimating a summation of the first values for all elements of the second data; and
training a neural network by using at least the summation of the first values for a permutation-invariant optimization metric.

2. The method of claim 1, wherein each pairwise distance is associated with a cross entropy of the element of the first data and the element of the second data.

3. The method of claim 1, wherein each pairwise distance is associated with a mean squared error of the element of the first data and the element of the second data.

4. The method of claim 1, wherein the normalizing function is such that the value of the normalizing function is above 0 and upper-bounded by a finite constant, a first derivative of the normalizing function is below 0, and a second derivative of the normalizing function is above 0 for an input that is equal to or more than 0.

5. The method of claim 1, wherein the normalizing function is an exponential decaying function.

6. The method of claim 1, wherein the de-normalizing function is an inverse function of the normalizing function.

7. The method of claim 1, wherein the permutation-invariant optimization metric is a network loss function of the neural network.

8. The method of claim 1, wherein the neural network is an autoencoder.

9. An apparatus comprising
a processor or a programmable circuitry; and
one or more computer readable mediums collectively including instructions that, when executed by the processor or the programmable circuitry, cause the processor or the programmable circuitry to perform operations including:
calculating a pairwise distance between each of a plurality of elements of a first data and each of a plurality of elements of a second data;
normalizing each pairwise distance with a normalizing function to obtain a normalized value corresponding to each pairwise distance;
de-normalizing a summation of the normalized values of all pairwise distances between a single element of the second data and each element of the first data with a de-normalizing function to obtain a first value, for each element of the second data;
estimating a summation of the first values for all elements of the second data; and
training a neural network by using at least the summation of the first values for a permutation-invariant optimization metric.

10. The apparatus of claim 9, wherein each pairwise distance is associated with a cross entropy of the element of the first data and the element of the second data.

11. The apparatus of claim 9, wherein each pairwise distance is associated with a mean squared error of the element of the first data and the element of the second data.

12. The apparatus of claim 9, wherein the normalizing function is such that the value of the normalizing function is above 0 and upper-bounded by a finite constant, a first derivative of the normalizing function is below 0 and a second derivative of the normalizing function is above 0 for an input that is equal to or more than 0.

13. The apparatus of claim 9, wherein the normalizing function is an exponential decaying function.

14. The apparatus of claim 9, wherein the de-normalizing function is an inverse function of the normalizing function.

15. A computer program product including one or more computer readable storage mediums collectively storing program instructions that are executable by a processor or programmable circuitry to cause the processor or programmable circuitry to perform operations comprising:
calculating a pairwise distance between each of a plurality of elements of a first data and each of a plurality of elements of a second data;
normalizing each pairwise distance with a normalizing function to obtain a normalized value corresponding to each pairwise distance; de-normalizing a summation of the normalized values of all pairwise distances between a single element of the second data and each element of the first data with a de-normalizing function to obtain a first value, for each element of the second data;
estimating a summation of the first values for all elements of the second data; and
training a neural network by using at least the summation of the first values for a permutation-invariant optimization metric.

16. The computer program product of claim 15, wherein each pairwise distance is associated with a cross entropy of the element of the first data and the element of the second data.

17. The computer program product of claim 15, wherein each pairwise distance is associated with a mean squared error of the element of the first data and the element of the second data.

18. The computer program product of claim 15, wherein the normalizing function is such that the value of the normalizing function is above 0 and upper-bounded by a finite constant, a first derivative of the normalizing function is below 0 and a second derivative of the normalizing function is above 0 for an input that is equal to or more than 0.

19. The computer program product of claim 15, wherein the normalizing function is an exponential decaying function.

20. The computer program product of claim 15, wherein the de-normalizing function is an inverse function of the normalizing function.
